(19) United States
(12) Patent Application Publication
(10) Pub. No.: US 2016/0100659 A1
(43) Pub. Date: Apr. 14, 2016

(54) Contact lens case with cleaning compartment

(71) Applicant: Ai Ishihara Harris, Torrance, CA (US)

(72) Inventor: Ai Ishihara Harris, Torrance, CA (US)

(21) Appl. No.: 14/512,443

(22) Filed: Oct. 12, 2014

(51) Int. Cl. A45C 11/00; B65D 25/28; B65D 41/00; G02C 13/00

(52) U.S. Cl. CPC A45C 11/005; G02C 13/008; B65D 25/28; B65D 41/00; B65D 2525/283

(57) ABSTRACT

The “Contact lens case with cleaning compartment” allows customers to hand clean, rub, and rinse their contact lens as a part of their contact lens case instead of cleaning their contact lens separately in the palm of their hand. This product allows the user to clean their contact lens within the wall structure of the contact case cleaning compartment. Apply a preferable amount of contact solution in the inside of the cleaning compartment, place your contact lens in the solution, and begin cleaning

### BACKGROUND OF THE INVENTION

(1) The Prior Art

For decades all prior contact lens cases such as U.S. patent Ser. No. 10/783,298, have not fully remedied a method that enables you to actually manually hand clean your contact lenses as a part of the contact lens case. This prior contact lens case is designed to simply carry solution for the purpose of still having to clean and rub your contact lenses in the palm of your hands. Furthermore other products such as U.S. Pat. Nos. 3,623,492, 4,653,519, and 4,559,662 holds contact lenses securely but still avoids the much needed manual hands on cleaning, rubbing, and rinsing method that dermatologist recommend contact lens wearers to do. Even with all of the powerful so called no rubbing contact lens solutions on the market dermatologist and FDA still highly recommend that users apply rubbing and rinsing techniques to their contact lenses to decrease the number of bacteria levels on the contact lenses so that the contact solution can do its job effectively.

(2) Advantages

Thus several advantages of one or more aspects are that you can clean and rinse off the contaminants on your contact lenses without ever having to use the palm of your hand. It only involves cleaning your contact lenses with the use of your index finger and thumb and not the use of the full hand that involves the palm. This method also avoids the user from ever applying contact lens solution on the hand which can find itself going all over the hand and floor. No longer will you have contaminated contact solution running all over your hands every time you remove your contact lens for cleaning.

### BRIEF SUMMARY OF THE INVENTION

The “Contact lens case with cleaning compartment” is used to hand clean your contact lenses in a third compartment chamber located in front of the left and right contact lens compartment chambers that stores the contact lenses. The inside surface area of the cleaning compartment chamber has a slope which helps the contact solution fall downward and stay within the chamber. Furthermore the cleaning compartment chamber contains a concave circular surface in the center that enables the user to place the convex side of the contact lens for a fitter cleaning while soaked in the contact solution. The user then applies rubbing pressure on the contact lens with use of the fingers to loosen the contaminants from the contact lens. Once the user is finished cleaning their contacts they can then pour the contaminated solution out from the cleaning compartment through the open wall structure. Finally the user can conveniently store their contact lenses until the next time for usage. This product provides a way to clean your contact lenses without the mess that is usually involved when cleaning your contact lenses with contact solution in the palm of your hand. The cap for the cleaning compartment chamber insures no dust or lint builds up on the surface.

### BRIEF DESCRIPTION OF THE SEVERAL VIEWS OF THE DRAWINGS

FIG. 1 is a perspective view of an embodiment of a contact lens case with cleaning compartment of the present disclosure.

FIG. 2 is a top view of the contact lens case with cleaning compartment of FIG. 1.

FIG. 3 is a bottom view of the contact lens case with cleaning compartment of FIG. 1.

FIG. 4 is a right side view of the contact lens case with cleaning compartment of FIG. 1.

FIG. 5 is a cross-sectional view of the contact lens case with cleaning compartment of FIG. 1.

### DESCRIPTION OF THE PREFFERED EMBODIMENT

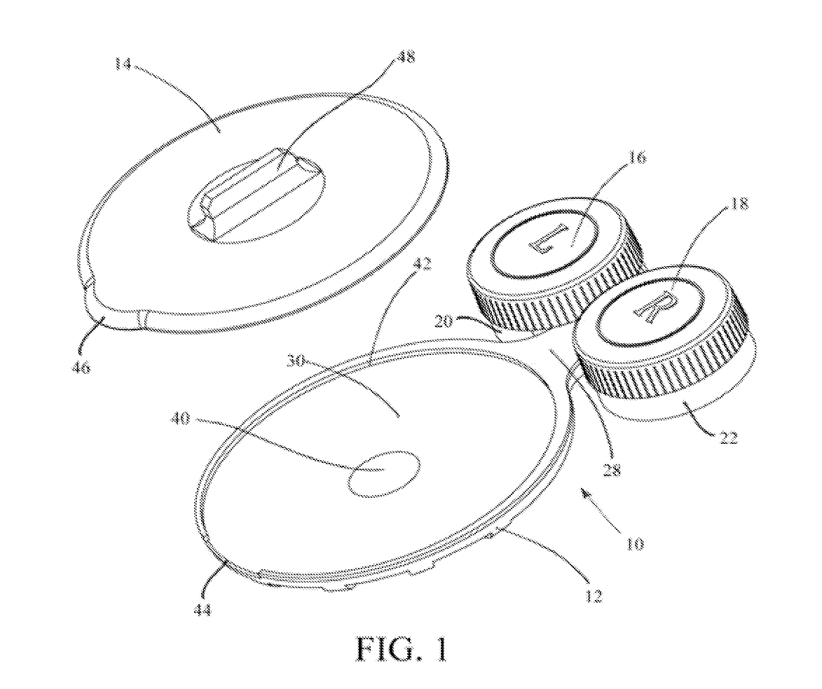

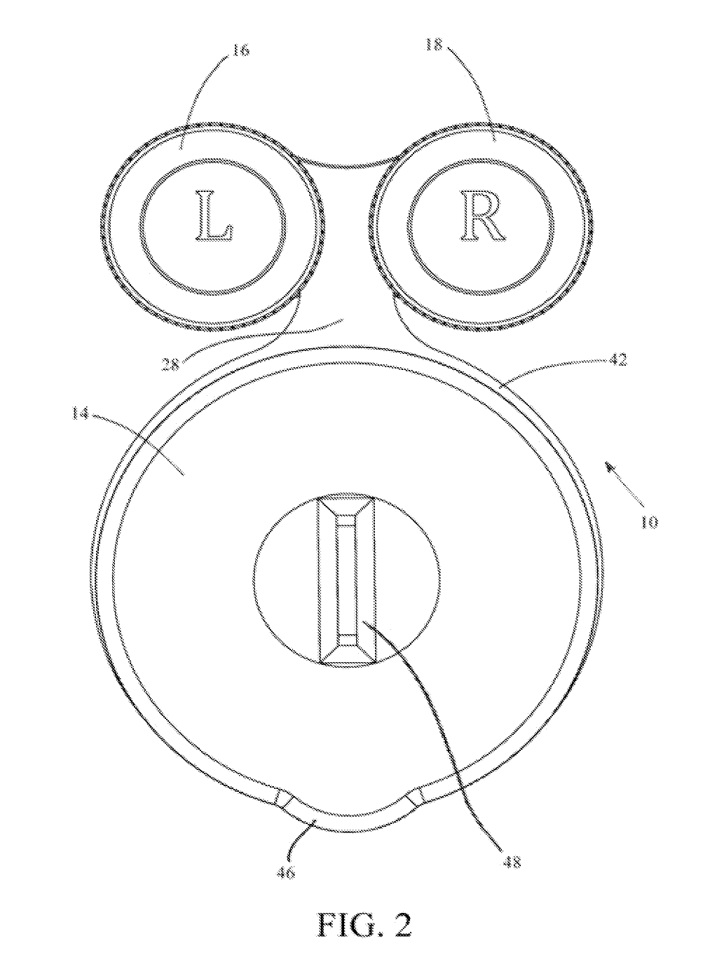

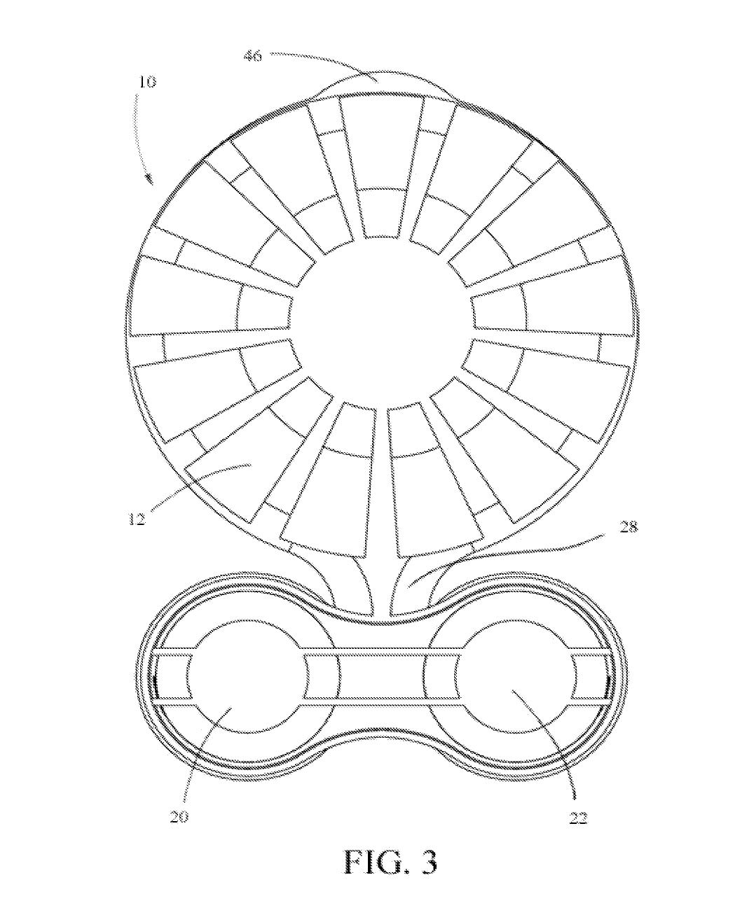

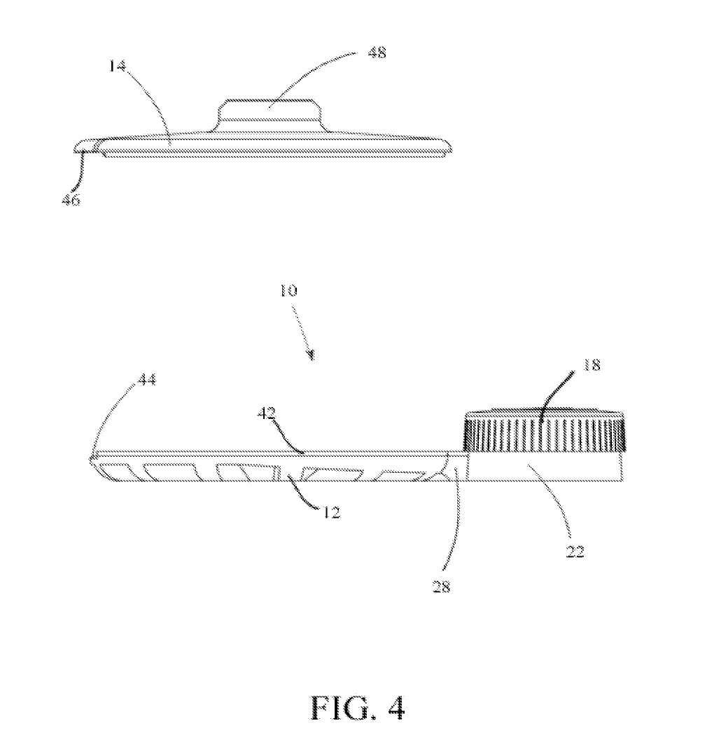

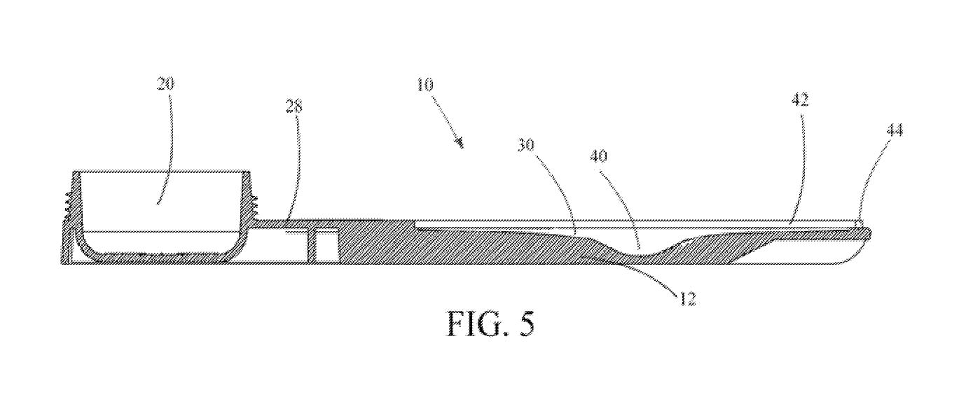

Referring now to FIGS. 1 through 5 of the drawings, a first embodiment of the contact lens case with cleaning compartment 10 of the present invention broadly includes a cleaning compartment chamber 12 which is the third compartment chamber and a removable cap 14 for the cleaning compartment chamber 12. The contact lens case with cleaning compartment 10 further includes a removable left (L) cap 16 and right (R) cap 18 for the corresponding left contact lens compartment chamber 20 and right contact lens compartment chamber 22.

In greater details, the cleaning compartment chamber 12 is located in front of the corresponding left contact lens compartment chamber 20 and right contact lens compartment chamber 22. Alternatively, the cleaning compartment chamber 12 could be located in the middle and back of the corresponding left contact lens compartment chamber 20 and right contact lens compartment chamber 22 (not shown). The inside of the cleaning compartment chamber 12 has a 360 degree sloped surface 30 that leads downward to a circular concave surface 40 located in the bottom center of the cleaning compartment chamber 12. The 360 degree sloped surface 30 allows the contact solution being poured onto the contact lens during cleaning to fall downward instead of flat and holds the contact solution within the wall structure 42 of the cleaning compartment chamber 12.

This circular concave surface 40 allows for a fitter cleaning of the convex surface of the contact lens during cleaning and to also show as a guideline on where to place the contact lens before cleaning is conducted. The cleaning compartment chamber 12 and corresponding left contact lens compartment chamber 20 and right contact lens compartment chamber 22 are all constructed together in which the extension arm structure 28 connects both the cleaning compartment chamber 12 and both corresponding contact lens compartment chambers.

The cleaning compartment chamber 12 is greater in diameter then the diameter of a singular contact lens compartment chamber. The greater diameter of the cleaning compartment chamber 12 gives the index finger more room to clean the contact lens at a straight angle due to long nails for some users. At the top of the cleaning compartment chamber 12 there is a wall structure 42 that enables the removable cap 14 for the cleaning compartment chamber 12 to fit within the wall structure 42. The wall structure 42 consist of an open wall 44 in the front of the cleaning compartment chamber 12 that enables the contaminated contact solution to be poured out more smoothly to prevent spillage when discarding.

The removable cap 14 for the cleaning compartment chamber 12 consist of a tab 46 on the side and a handle 48 on top for easy gripping of the fingers to take off the removable cap 14 either way. Once the cleaning process for the contact lenses are completed within the cleaning compartment chamber 12 the contact lenses can then be easily transferred into the corresponding left contact lens compartment chamber 20 and right contact lens compartment chamber 22 and secured with the left (L) cap 16 and right (R) cap 18 for storage.

Accordingly most users avoid the step of cleaning their contact lenses in the palm of their hand and end up with high bacteria levels still on their contact lenses when being stored. Users will have no need to use the palm of their hand to clean their contact lenses and at end of cleaning their hand will not be covered with dirty contact solution. It is common for contact lens users to use their index finger and thumb to take out their contacts lenses and now they can use the same fingers to hand clean their contact lenses instead of having to transfer the contact lenses for cleaning in the palm of their hand. In addition the user can conveniently clean and store their contact lenses in one place instead of hand cleaning their contact lenses separately.

It is understood that the present invention is not limited to the embodiments described above and all embodiments within the scope of the following claims. While the invention has been illustrated and described as embodiments of a cleaning compartment chamber 12 configured with a contact lens case it is understood that various modifications can be made such as the cleaning compartment chamber 12 being placed in the middle or back of the corresponding left contact lens compartment chamber 20 and right contact lens compartment chamber 22 instead of the front.

### DETAILED DESCRIPTION OF THE INVENTION

The “Contact lens case with cleaning compartment” is a contact lens case that is equipped with a third compartment chamber for hand cleaning, rubbing, and rinsing your contact lenses. The third compartment chamber for cleaning your contact lenses is located in front of the left and right contact lens compartment chambers which is extended out by a structured extension arm. The third compartment chamber is greater in diameter then that of a singular contact lens chamber. The inside of the third cleaning compartment chamber has a 360 degree sloped surface and consist of a circular concave shape in the bottom center which is shaped for the convex side of the contact lens or as a guidance on where to place the contact lens for cleaning. Contact solution is then added in the third cleaning compartment chamber in which the user then uses his or her finger to begin cleaning, rubbing, or rinsing the contact lens within the cleaning compartment chamber. Once the user is finished with cleaning and rubbing their contact lenses the solution is discarded through the open wall structure of the cleaning compartment chamber. The cleaning compartment chamber is designed with a wall structure with an opening that enables the contaminated contact solution to pour out of the cleaning compartment chamber easier. A cap for the cleaning compartment chamber is used to make sure no dust or lint collects on the surface. The rim of the cap for the cleaning compartment chamber is designed long enough to cover the opening of the wall structure to insure no dust or lint gets inside.

I claim:

1: “Contact lens case with cleaning compartment”, comprising:
a. A left contact lens compartment chamber.
b. A right contact lens compartment chamber.
c. A third compartment chamber.
d. A cap for said left contact lens compartment chamber.
e. A cap for said right contact lens compartment chamber.
f. A cap for said third compartment chamber.

2: The contact lens case with cleaning compartment of claim 1, wherein said third compartment chamber is in front of said left and right contact lens compartment chambers.

3: The contact lens case with cleaning compartment of claim 1, wherein said third compartment chamber is greater in diameter then that of a singular contact lens compartment chamber.

4: The contact lens case with cleaning compartment of claim 1, wherein said third compartment chamber extends out from an extension arm structure.

5: The contact lens case with cleaning compartment of claim 1, wherein said third compartment chamber has an inner 360 degree sloped surface.

6: The contact lens case with cleaning compartment of claim 1, wherein said third compartment chamber includes a concave circular surface in the bottom center.

7: The contact lens case with cleaning compartment of claim 1, wherein said third compartment chamber includes a wall structure.

8: The contact lens case with cleaning compartment of claim 7, wherein said wall structure includes an open wall structure in front.

9: The contact lens case with cleaning compartment of claim 1, wherein said cap for said third compartment chamber includes a tab on side.

10: The contact lens case with cleaning compartment of claim 1, wherein said cap for said third compartment chamber includes a handle on top.
